(19) United States
(12) Patent Application Publication
(10) Pub. No.: US 2026/0186300 A1
(43) Pub. Date: Jul. 2, 2026

(54) VEHICLE HOLOGRAPHIC HEAD-UP DISPLAY APPARATUS AND METHOD FOR PROVIDING HOLOGRAM USING THE SAME

(71) Applicant: ELECTRONICS AND TELECOMMUNICATIONS RESEARCH INSTITUTE, Daejeon (KR)

(72) Inventor: Jin-Su LEE, Daejeon (KR)

(73) Assignee: ELECTRONICS AND TELECOMMUNICATIONS RESEARCH INSTITUTE, Daejeon (KR)

(21) Appl. No.: 19/434,560

(22) Filed: Dec. 29, 2025

(30) Foreign Application Priority Data
Dec. 27, 2024 (KR) 10-2024-0197929
Nov. 24, 2025 (KR) 10-2025-0179811

(51) Int. Cl. G02B 27/01; G02B 27/28

(52) U.S. Cl. CPC G02B 27/0103; G02B 27/283

(57) ABSTRACT

Disclosed herein are a vehicle holographic head-up display apparatus and a method for providing hologram using the same. The vehicle holographic head-up display apparatus includes a holographic projection module including two spatial light modulators configured to generate a hologram pattern by modulating laser light separated through a polarization beam splitter, and including a single optical system shared by the left and right eyes, and a windshield module having an increased optical path based on reflection of light.

### CROSS REFERENCE TO RELATED APPLICATIONS

This application claims the benefit of Korean Patent Application Nos. 10-2024-0197929, filed December 27, 2024, and 10-2025-0179811, filed November 24, 2025, which are hereby incorporated by reference in their entireties into this application.

### BACKGROUND OF THE INVENTION

### 1. Technical Field

The present disclosure relates generally to a holographic head-up display technology for a vehicle, and more particularly to an ultra-compact holographic projection optical engine, which is an essential element for implementing a vehicle holographic head-up display.

### 2. Description of the Related Art

Digital holographic display technology is a technology that calculates amplitude and phase information of an interference fringe generated by an interference phenomenon between an object beam reflected from an object and a reference beam, and optically reconstructs the calculated information to reproduce three-dimensional information of the object. In particular, the digital holographic display technology replaces the complex recording and reconstruction processes of analog holograms with computational simulation, thereby enabling precise visualization of high-resolution three-dimensional information. Accordingly, the technology may be utilized in various fields, including medical fields (surgery, diagnosis), educational fields (stereoscopic educational content), military fields (battlefield situational awareness), and automotive fields (UHD, infotainment).

Generally, a vehicle head-up display is mounted in the vicinity of a driver-side dashboard, and as vehicle performance continues to advance, an autonomous driving technology proliferates, and a vehicle model diversifies, demands for ultra-miniaturization and ultra-lightweight configuration of a HUD module itself are rapidly increasing. At the same time, in order to ensure visual convenience for a driver, high-performance optical characteristics, such as a wide field of view, a sufficiently large eye-box, and a wide depth representation capability, are essentially required.

As conventional technologies, an optical waveguide-based beam replication technology in which mirrors with different transmittance and reflectance are sequentially arranged to replicate beams or an eye tracking-based dynamic eye-box expansion technology has been studied. However, the former requires expensive optical components with precise multi-layer coating, while the latter necessitates a high-speed/high-precision eye tracking module, resulting in significant increases in system complexity and cost.

Therefore, there is a need for research and development of an optical structure that can secure a wide field of view, eye-box, and depth representation capability, while simultaneously reducing the overall volume of a HUD optical engine effectively.

### [Prior Art Documents]

### [Patent Documents]

(Patent Document 1) Korean Patent Application Publication No. 10-2025-0035448, Publication Date: March 12, 2025 (Title: Apparatus and Method for Extracting Aberration of Hologram Optical System Based on Image Optimization)

### SUMMARY OF THE INVENTION

Accordingly, the present disclosure has been made keeping in mind the above problems occurring in the prior art, and an object of the present disclosure is to implement a vehicle holographic head-up display apparatus with a very small volume.

Another object of the present disclosure is to provide an ultra-compact holographic head-up display projection module having an optical system structure that satisfies optical performance requirements such as eye-box (EB), Field of View (FoV), Virtual Image Distance (VID), Look Down Angle (LDA), and Image Distortion.

A further object of the present disclosure is to implement a vehicle holographic head-up display apparatus that expands a field of view and expands an eye-box through gapless arrangement or overlapping, thereby realizing a high-quality hologram stereoscopic image through optimization of a phase hologram pattern.

Yet another object of the present disclosure is to provide a binocular holographic head-up display projection optical engine by implementing a holographic projection module employing a polarized/non-polarized binocular optical system and a 2D Dammann beam splitter/eye tracking module, and implementing a windshield module based on a light guide/polarization reflection folding optics.

In accordance with an aspect of the present disclosure to accomplish the above objects, there is provided a vehicle holographic head-up display apparatus including a holographic projection module including two spatial light modulators configured to generate a hologram pattern by modulating laser light separated through a polarization beam splitter, and including a single optical system shared by the left and right eyes, and a windshield module having an increased optical path based on reflection of light.

The single optical system may correspond to any one of a first type in which, after converting the hologram pattern into an image, the image is separated into left-eye and right-eye images using a polarization beam splitter, a second type in which the hologram pattern is separated into left-eye and right-eye patterns using the polarization beam splitter and the separated patterns are then converted into images by a single lens, a third type in which the hologram pattern is separated into left-eye and right-eye patterns using the polarization beam splitter and the separated patterns are converted into images using left-eye and right-eye lenses, respectively, and a fourth type in which, after converting the hologram pattern into an image, the image is separated into left-eye and right-eye images using an inclined mirror.

The single optical system may further include a first lens and a second lens for pixel-spacing adjustment and eye-box expansion, a transmissive diffractive optical element located between the first lens and the second lens or before or after a fourth lens, and at least one third lens for converting the hologram pattern into an image.

The transmissive diffractive optical element may be designed to expand an eye-box by replicating a hologram with an identical intensity based on control of diffraction and interference of light such that the replicated holograms are arranged without gaps or overlapped, and to adjust phase values of pixels arranged without gaps or overlapped to correspond to preset parameters, thereby allowing the hologram to be expressed as a single image without distortion.

The single optical system may further include two beam steering mirrors configured to perform eye tracking based on two-axis control.

The windshield module may correspond to any one of a box type using a half mirror or a polarizing optical element, and a light-guide type using two mirrors arranged in parallel.

The box type may include a half-mirror type in which light is reflected based on the half mirror, thereby increasing the optical path, and a polarization reflection type in which any polarized light emitted from the holographic projection module is repeatedly reflected based on a quarter waveplate, a 50:50 beam splitter, and a reflective linear polarizer, thereby increasing the optical path.

The light-guide type may increase the optical path by mutually reflecting a hologram signal incident at an oblique angle between two mirrors arranged in parallel.

The windshield module may include a free-form lens designed with a free-form surface to compensate for optical aberrations according to a curvature of a surface on which an erect virtual image of the hologram pattern is formed.

In accordance with another aspect of the present disclosure to accomplish the above objects, there is provided a hologram providing method performed by a vehicle holographic head-up display apparatus, the hologram providing method including generating, by a holographic projection module, a hologram pattern by modulating laser light separated through a polarization beam splitter based on two spatial light modulators, projecting, by the holographic projection module, an image corresponding to the hologram pattern onto a windshield module using a single optical system shared by a left eye and a right eye, and implementing, by the windshield module, a hologram based on the image through an increased optical path based on reflection of light.

The single optical system may correspond to any one of a first type in which, after converting the hologram pattern into an image, the image is separated into left-eye and right-eye images using a polarization beam splitter, a second type in which the hologram pattern is separated into left-eye and right-eye patterns using the polarization beam splitter and the separated patterns are then converted into images by a single lens, a third type in which the hologram pattern is separated into left-eye and right-eye patterns using the polarization beam splitter and the separated patterns are converted into images using left-eye and right-eye lenses, respectively, and a fourth type in which, after converting the hologram pattern into an image, the image is separated into left-eye and right-eye images using an inclined mirror.

The single optical system may further include a first lens and a second lens for pixel-spacing adjustment and eye-box expansion, a transmissive diffractive optical element located between the first lens and the second lens or before or after a fourth lens, and at least one third lens for converting the hologram pattern into an image.

The transmissive diffractive optical element may be designed to expand an eye-box by replicating a hologram with an identical intensity based on control of diffraction and interference of light such that the replicated holograms are arranged without gaps or overlapped, and to adjust phase values of pixels arranged without gaps or overlapped to correspond to preset parameters, thereby allowing the hologram to be expressed as a single image without distortion.

The single optical system may further include two beam steering mirrors configured to perform eye tracking based on two-axis control.

The windshield module may correspond to any one of a box type using a half mirror or a polarizing optical element, and a light-guide type using two mirrors arranged in parallel.

The box type may include a half-mirror type in which light is reflected based on the half mirror, thereby increasing the optical path, and a polarization reflection type in which any polarized light emitted from the holographic projection module is repeatedly reflected based on a quarter waveplate, a 50:50 beam splitter, and a reflective linear polarizer, thereby increasing the optical path.

The light-guide type may increase the optical path by mutually reflecting a hologram signal incident at an oblique angle between two mirrors arranged in parallel.

The windshield module may include a free-form lens designed with a free-form surface to compensate for optical aberrations according to a curvature of a surface on which an erect virtual image of the hologram pattern is formed.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 to 4 are diagrams illustrating a holographic projection module including respective optical systems for left and right eyes, and a holographic head-up display apparatus using the same;

FIGS. 5 and 6 are diagrams illustrating a holographic projection module according to an embodiment of the present disclosure;

FIGS. 7 and 8 are diagrams illustrating a holographic projection module in which the left and right eyes are configured using a single optical system, and an ultra-compact holographic head-up display apparatus using the same, according to an embodiment of the present disclosure;

FIGS. 9 and 10 are diagrams illustrating an example of a holographic projection module according to the present disclosure;

FIGS. 11 to 14 are diagrams illustrating the optical system configuration of a holographic projection module according to an embodiment of the present disclosure;

FIGS. 15 and 16 are diagrams illustrating an example in which eye-boxes are overlapped by a transmissive diffractive optical element according to the present disclosure;

FIGS. 17 and 18 are diagrams illustrating an example in which eye-boxes are arranged without gaps by a transmissive diffractive optical element according to the present disclosure;

FIGS. 19 and 20 are diagrams illustrating a holographic projection module including a beam steering mirror according to an embodiment of the present disclosure;

FIG. 21 is a diagram illustrating an example of a travel path of laser light using a beam steering mirror according to the present disclosure;

FIGS. 22A and 22B are diagrams illustrating an example of an expanded eye-box according to the present disclosure;

FIGS. 23 to 25 are diagrams illustrating a box-type windshield module according to an embodiment of the present disclosure;

FIG. 26 is a diagram illustrating an example of a half-mirror type in the box-type windshield module according to the present disclosure;

FIG. 27 is a diagram illustrating an example of a polarization reflection type in the box-type windshield module according to the present disclosure;

FIGS. 28 to 30 are diagrams illustrating a light-guide-type windshield module according to an embodiment of the present disclosure;

FIGS. 31 and 32 are diagrams illustrating a polarization reflection folding type windshield module according to an embodiment of the present disclosure;

FIG. 33 is a diagram illustrating an example of a polarization reflection folding type in the box-type windshield module according to the present disclosure;

FIG. 34 is a diagram illustrating an example of the basic principle of continuous VID adjustment in a holographic head-up display;

FIG. 35 is a diagram illustrating an example of a wavefront map of a freeform lens according to the present disclosure;

FIGS. 36 to 39 are diagrams illustrating an example comparing the degree of distortion when a spherical lens is used and when a freeform lens is used;

FIG. 40 is an operational flowchart illustrating a hologram providing method according to an embodiment of the present disclosure; and

FIGS. 41 and 42 are operational flowcharts illustrating a hologram providing process in an expanded eye-box according to an embodiment of the present disclosure in detail.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

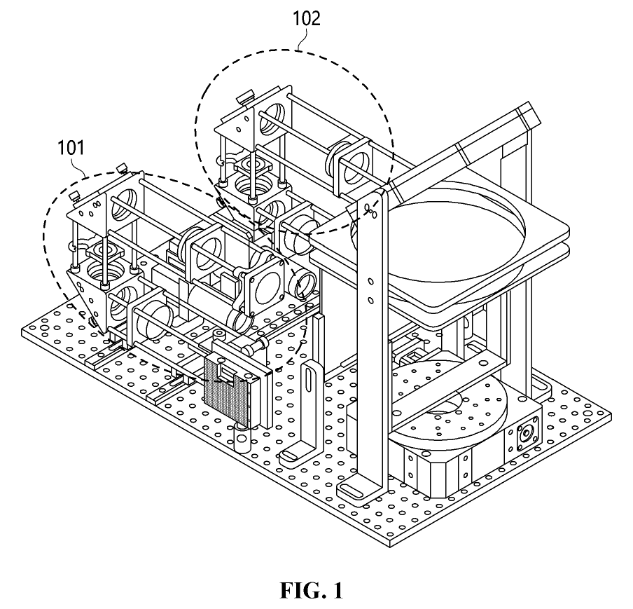

FIGS. 1 to 4 are diagrams illustrating a holographic projection module including independent optical systems for left and right eyes, and a holographic head-up display apparatus using the same.

Referring to FIGS. 1 to 4, it can be seen that the holographic head-up display apparatus includes a holographic projection module that projects a hologram to any distance, and a windshield module that transmits the projected hologram image to the pupil.

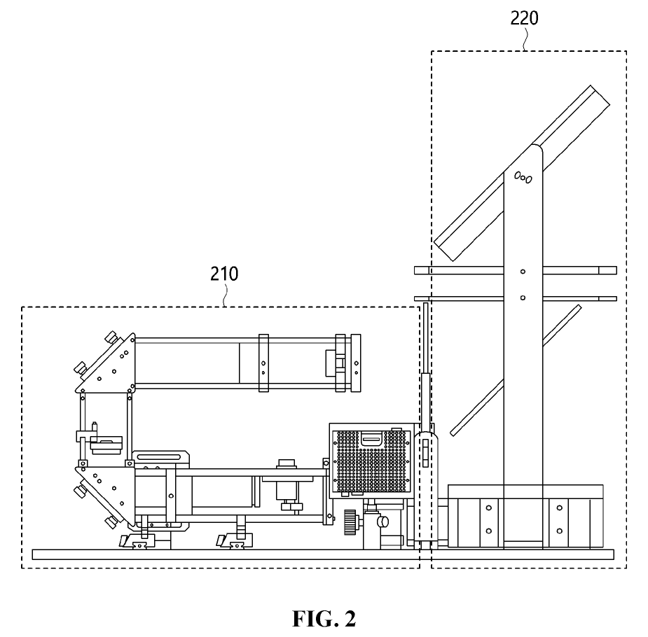

In this case, FIG. 1 illustrates a holographic head-up display apparatus including a holographic projection module including a right-eye optical system 101 and a left-eye optical system 102, respectively. FIG. 2 is a side view of such a holographic head-up display apparatus, showing that it is composed of a holographic projection module 210 and a windshield module 220.

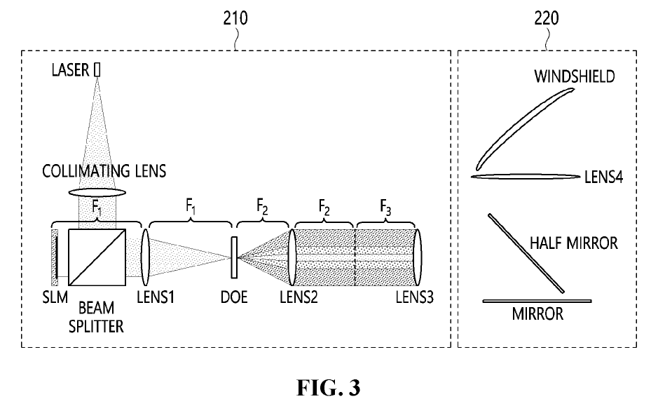

In this case, FIG. 3 illustrates the optical system of the holographic projection module 210 and the optical system of the windshield module 220, respectively. The system includes a Lens 1 (collimating lens) for collimating laser light, a spatial light modulator for controlling a phase or amplitude, Lens 2 and Lens 3 for adjusting pixel spacing and expanding an eye-box, a 2D diffractive optical element, and a Lens 4 for projecting a hologram reconstructed image to any position.

That is, since the holographic head-up display apparatus illustrated in FIG. 1 includes both the right-eye optical system 101 and the left-eye optical system 102, the optical system of the holographic projection module 210 illustrated in FIG. 3 may be arranged in pairs.

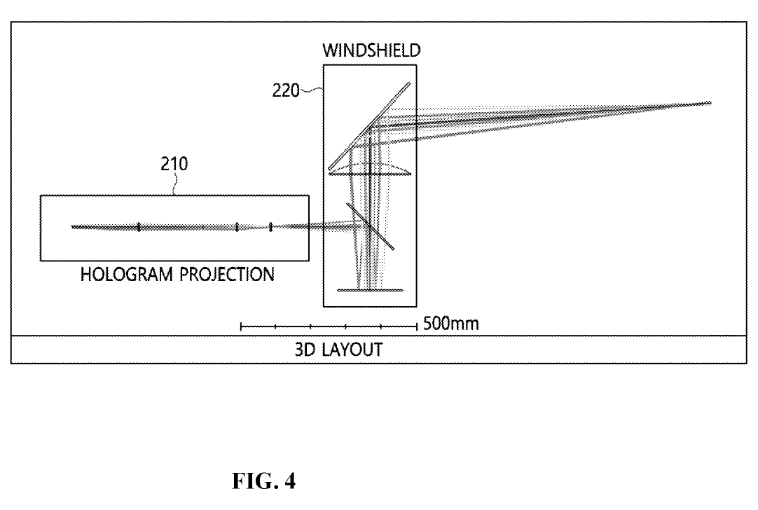

FIG. 4 shows the path of the laser light in the optical system of FIG. 3. That is, it can be seen that light projected from the holographic projection module 210 passes through the optical system of the windshield module 220 and is reconstructed as a hologram in front of a windshield.

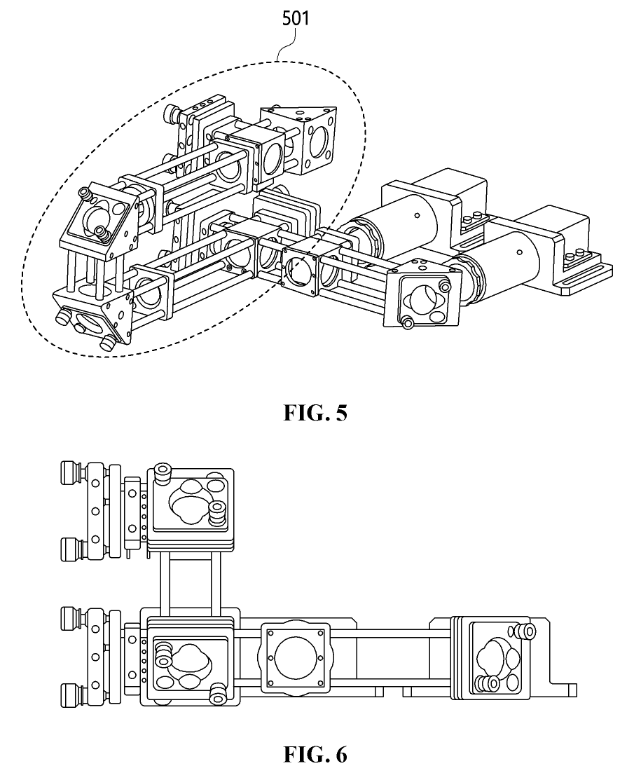

FIGS. 5 and 6 are diagrams illustrating a holographic projection module according to an embodiment of the present disclosure.

Referring to FIGS. 5 and 6, the holographic projection module according to an embodiment of the present disclosure may include a single optical system 501 shared by the left and right eyes. In this case, FIG. 6 is a side view of the holographic head-up display apparatus illustrated in FIG. 5, and the detailed configuration of the optical system may be represented as illustrated in FIGS. 11 to 14.

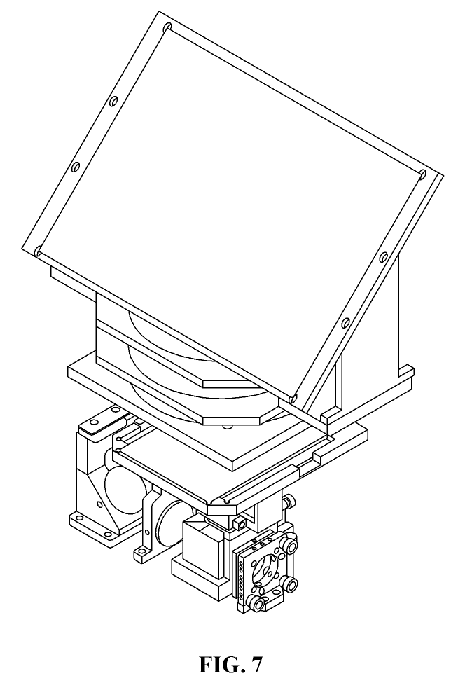

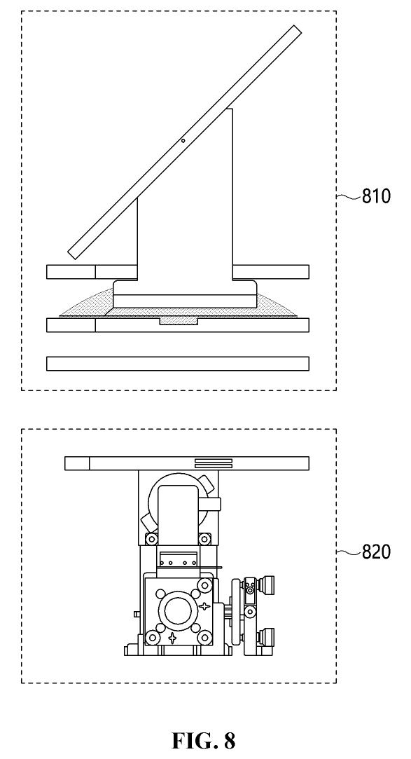

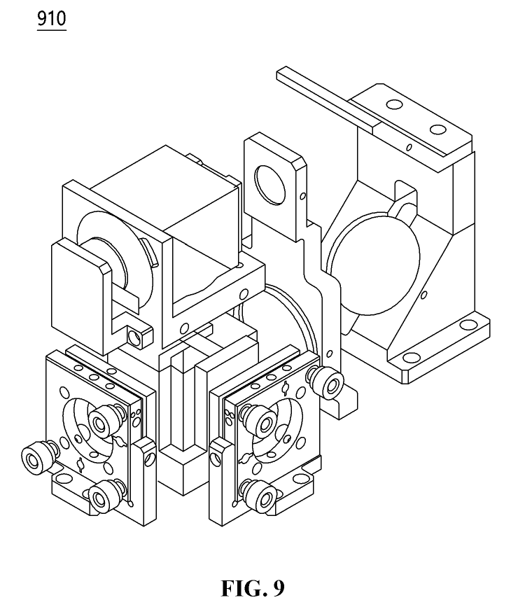

FIGS. 7 and 8 are diagrams illustrating a holographic projection module in which the left and right eyes are configured using a single optical system, and an ultra-compact holographic head-up display apparatus using the same, according to an embodiment of the present disclosure.

Referring to FIGS. 7 and 8, the holographic projection module in which the left and right eyes share the single optical system and the ultra-compact holographic head-up display apparatus using the same, according to an embodiment of the present disclosure, may include a windshield module 810 and a holographic projection module 820.

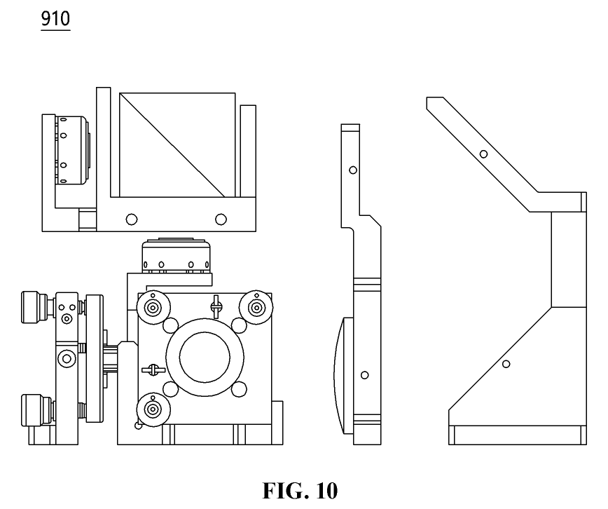

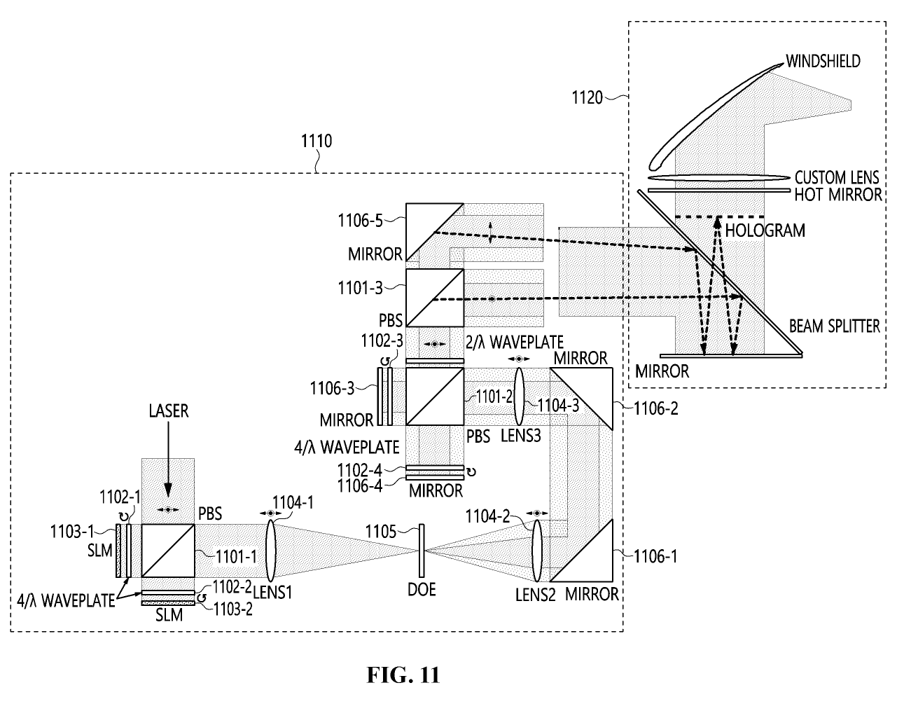

FIGS. 9 and 10 are diagrams illustrating an example of a holographic projection module according to the present disclosure.

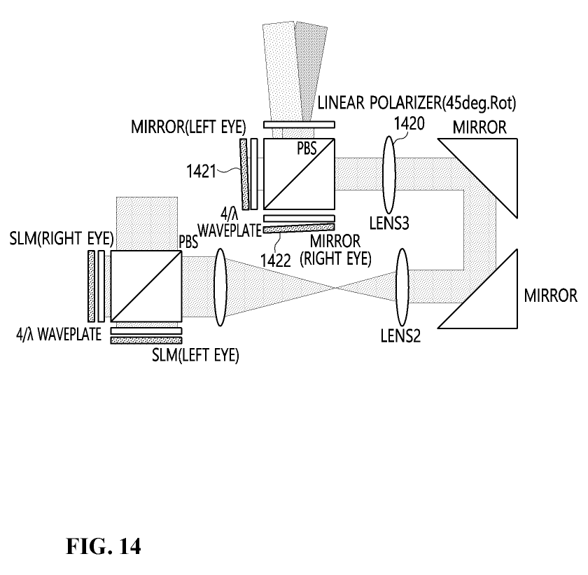

Referring to FIGS. 9 and 10, a holographic projection module 910 according to an embodiment of the present disclosure may include a single optical system shared by the left and right eyes. The detailed configuration of the optical system may be represented as illustrated in FIG. 14.

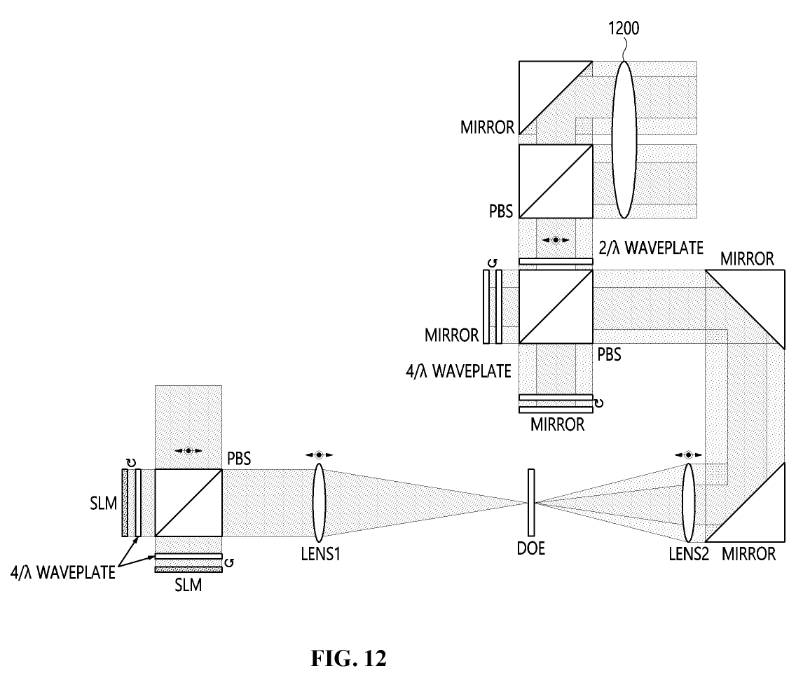

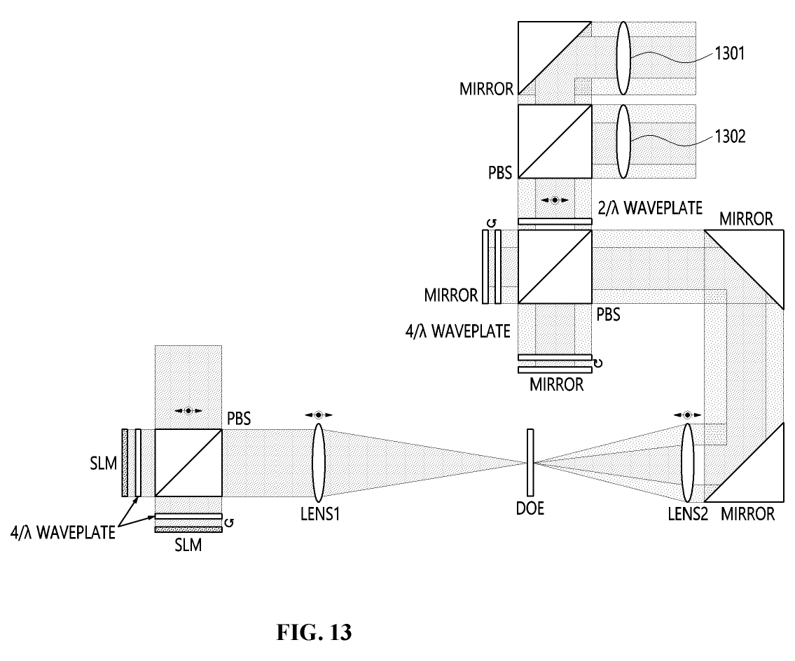

In this case, a single optical system 501 shared by the left and right eyes, as illustrated in FIG. 5, may correspond to any one of the following types: a first type in which the hologram pattern is converted into an image and then the image is separated into left-eye and right-eye images using a polarization beam splitter, as illustrated in FIG. 11, a second type in which the hologram pattern is separated into left-eye and right-eye patterns using a polarization beam splitter and then the separated patterns are converted into images using a single lens, as illustrated in FIG. 12, a third type in which the hologram pattern is separated into left-eye and right-eye patterns using a polarization beam splitter and then the separated patterns are converted into images using left-eye and right-eye lenses, respectively, as illustrated in FIG. 13, and a fourth type in which the hologram pattern is converted into an image and then is separated into left-eye and right-eye images using an inclined mirror.

In this case, the single optical system 501 shared by the left and right eyes may include two spatial light modulators 1103-1 and 1103-2 that generate hologram patterns by modulating laser beams separated by a polarization beam splitter 1101-1. In addition, the single optical system 501 may further include a first lens 1104-1 and a second lens 1104-2 for adjusting pixel spacing and expanding the eye-box, a transmissive diffractive optical element 1105 disposed between the first lens 1104-1 and the second lens 1104-2 or before/after the fourth lens, and at least one third lens 1104-3 for converting the hologram pattern into an image.

More specifically, collimated light from the laser is separated by the polarization beam splitter 1101-1 into two orthogonal linear polarization components, which are respectively incident on the SLMs 1103-1 and 1103-2 and then rotated by 90° by quarter waveplates 1102-1 and 1102-2 prior to emission. Thereafter, the light passes through the first and second lenses 1104-1 and 1104-2 for pixel-spacing adjustment and eye-box expansion, the diffractive optical element (DOE) 1105, and the third lens 1104-3 for projecting the hologram reconstructed image to any position. Subsequently, to compensate for an optical path difference between the left and right eyes, the light again passes through a PBS 1101-2 and a quarter waveplate 1102-3, and then 0° and 90° linearly polarized components are separated by a PBS 1101-3, so that left-eye and right-eye separated hologram reconstructed images may be realized.

In this case, referring to the first type illustrated in FIG. 11, since the third lens 1104-3 is positioned before the polarization beam splitter 1101-3, the image converted through the third lens 1104-3 is subsequently separated into the left-eye and right-eye images by polarization beam splitters 1106-5 and 1101-3, and then projected to a windshield module 1120.

It can be seen that the second type illustrated in FIG. 12 and the third type illustrated in FIG. 13 are configured such that third lenses 1200, 1301 and 1302 are positioned after the polarization beam splitter 1101-3, and thus the hologram pattern is converted into an image after being separated into left-eye and right-eye patterns.

In addition, referring to the fourth type illustrated in FIG. 14, the image converted by a third lens 1410 is subsequently separated into left-eye and right-eye images by mirrors 1421 and 1422, which are inclined at any angles, and then projected to the windshield module.

In this case, each optical system corresponding to the respective types has its own advantages.

For example, in the case of the first type illustrated in FIG. 11, the third type illustrated in FIG. 13, and the fourth type illustrated in FIG. 14, the left-eye angle and the right-eye angle may be independently adjusted, thereby providing an advantage of allowing customized adjustment according to individual differences in ocular structure. That is, by adjusting relative positions of images perceived by the left eye and the right eye so that the hologram image is appropriately incident on both eyes, the two eyes may be caused to naturally achieve focus.

As another example, in the second type illustrated in FIG. 12, only a single lens 1200 needs to be adjusted to achieve focus, and therefore precise calibration is not required.

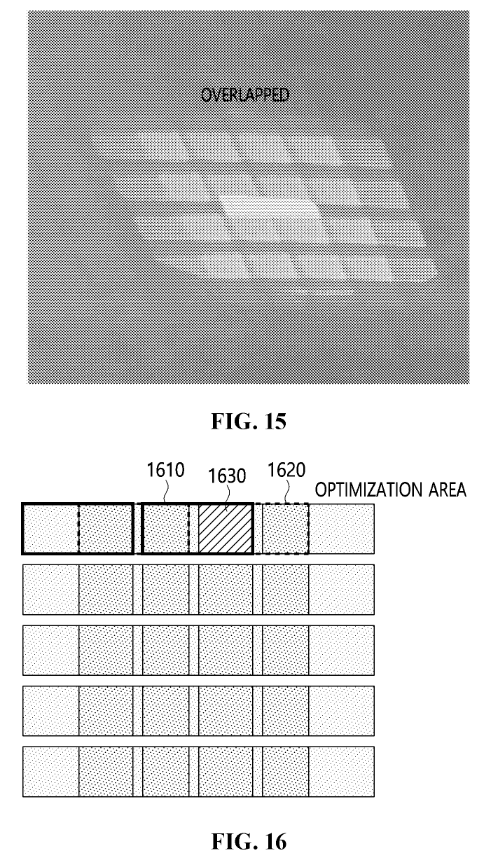

In this case, the transmissive diffractive optical element controls diffraction and interference of light so as to replicate and overlap eye-boxes as illustrated in FIG. 15, while adjusting the phase values of pixels within an overlapped area according to preset parameters, thereby enabling the hologram to be represented as a single image without distortion. The transmissive diffractive optical element may be designed such that replicated signals have the same intensity, and may be disposed at one or more positions within the holographic projection module and the windshield module.

In this context, the eye-box refers to a space in which an image generated by the display is properly perceived by the user’s eyes, and the user must position his or her eyes within the eye-box area in order to clearly view the image. That is, the wider the eye-box, the more easily the hologram may be viewed.

Diffraction by the transmissive diffractive optical element causes multiple optical paths to overlap, thereby generating multiple eye-boxes. These eye-boxes overlap with one another, as illustrated in FIG. 15, resulting in eye-box overlap.

For example, referring to FIG. 16, multiple replicated areas 1620 may be generated with respect to an original eye-box area 1610, and as these areas overlap, an overlapping area 1630 is formed. In the overlapping area 1630, pixels from the two areas 1610 and 1620 between replicated hologram signals overlap to create a hologram. In other words, the phase values produced by the overlapped pixels may generate the hologram. In the present disclosure, the phase values may be optimized by presetting parameters so that such a hologram is prevented from being perceived as triple or quadruple images but is clearly perceived as a single image.

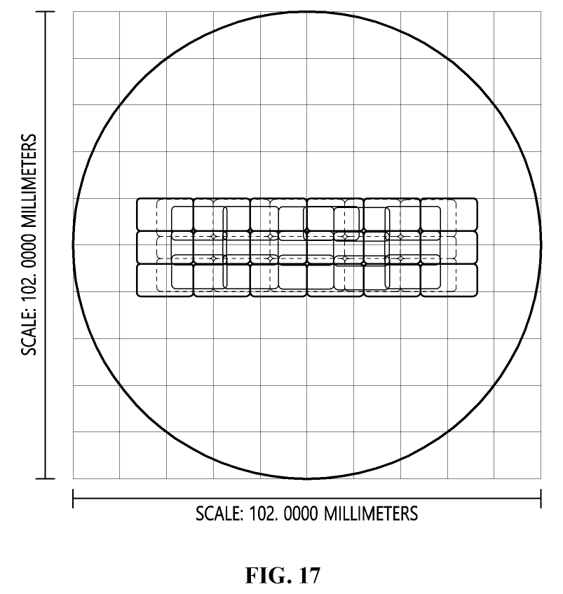

In this case, the transmissive diffractive optical element controls diffraction and interference of light to replicate eye-boxes with the same intensity and arrange them without gaps, as illustrated in FIG. 17, thereby expanding the eye-boxes. The expanded eye-boxes exhibit different distributions depending on the wavelength, and may be designed to reproduce the hologram signal by identifying effective-area pixels through an eye tracking technology. The transmissive diffractive optical element is designed such that the replicated signals have the same intensity.

In this case, the transmissive diffractive optical element may be designed as a 2D Dammann beam splitter so that an input signal is replicated in n × n orders with the same intensity.

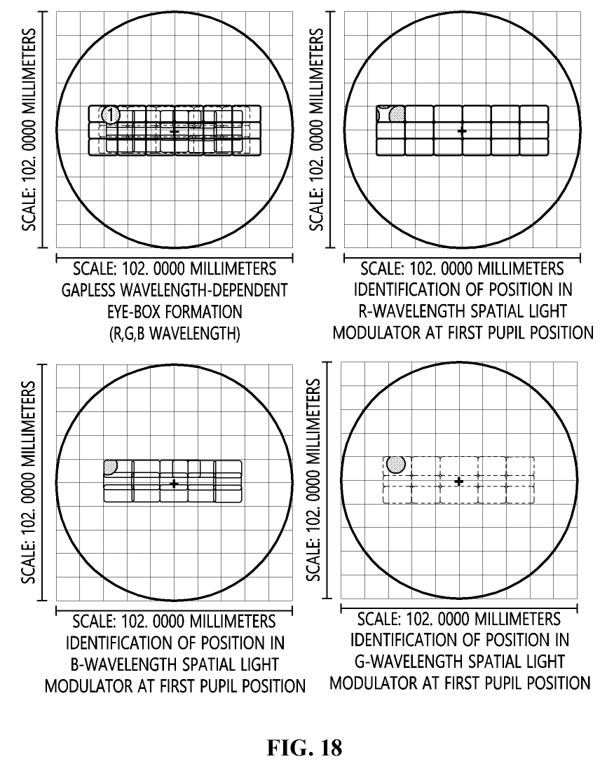

For example, referring to FIG. 18, when the transmissive diffractive optical element is designed such that the eye-boxes of a red wavelength (R wavelength) are arranged without any gaps, eye-boxes of blue (B) and green (G) wavelengths overlap due to reduced diffraction angles resulting from their shorter wavelengths. In this case, by reproducing only pixels corresponding to the eye-box for each wavelength according to the positions of pupils of both eyes, the image may be prevented from being perceived as a double or triple image and may be cleanly perceived as a single image.

In addition, in the present disclosure, the single optical system shared by the left and right eyes may operate in a configuration that includes a first lens and a second lens for pixel-spacing adjustment and eye-box expansion, a reflective diffractive optical element disposed between the first lens and the second lens or before/after the fourth lens, at least one third lens for converting the hologram pattern into an image, and two beam steering mirrors for performing eye tracking based on two-axis control.

In this case, by tracking pupil movement through two beam steering mirrors, a dynamic eye-box may be implemented at a level sufficient to cover both eyes.

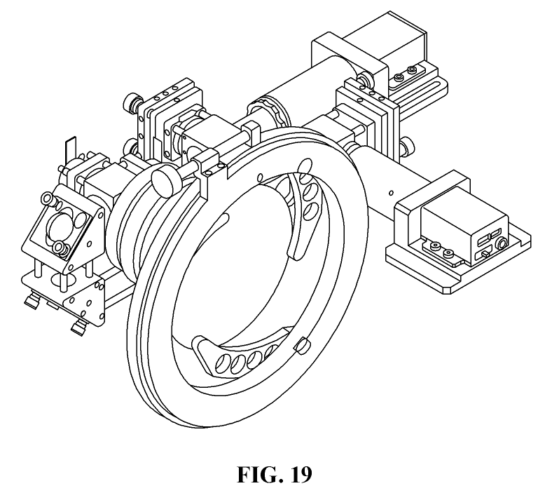

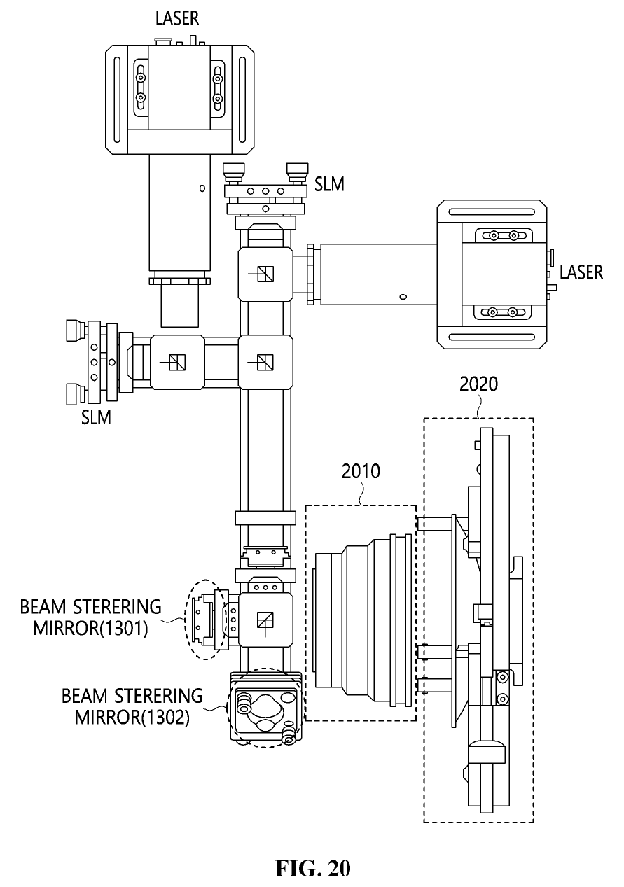

For example, FIGS. 19 and 20 illustrate a holographic projection module including beam steering mirrors according to an embodiment of the present disclosure, and referring to the side view illustrated in FIG. 20, it can be seen that two beam steering mirrors 2001 and 2002 are used.

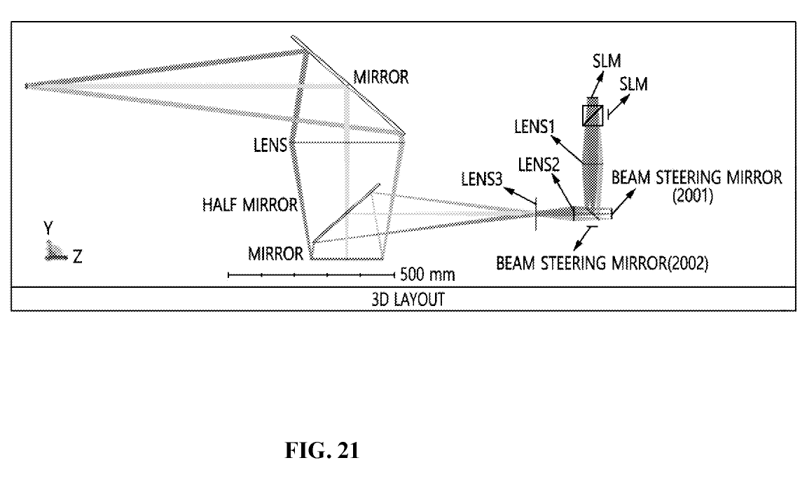

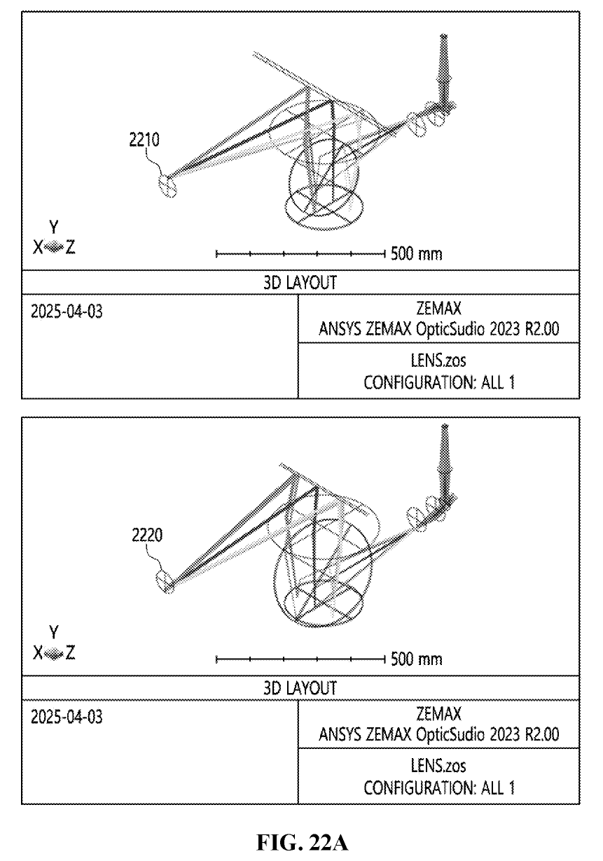

In this case, the precise positions of the two beam steering mirrors 2001 and 2002 may be identified with reference to FIG. 21.

For example, referring to FIG. 21, the beam steering mirrors 2001 and 2002 may be located between the first lens (Lens 1) and the second lens (Lens 2) within the single optical system shared by the left and right eyes.

Thus, in this case, the optical system may be configured to include a reflective diffractive optical element instead of the transmissive diffractive optical element.

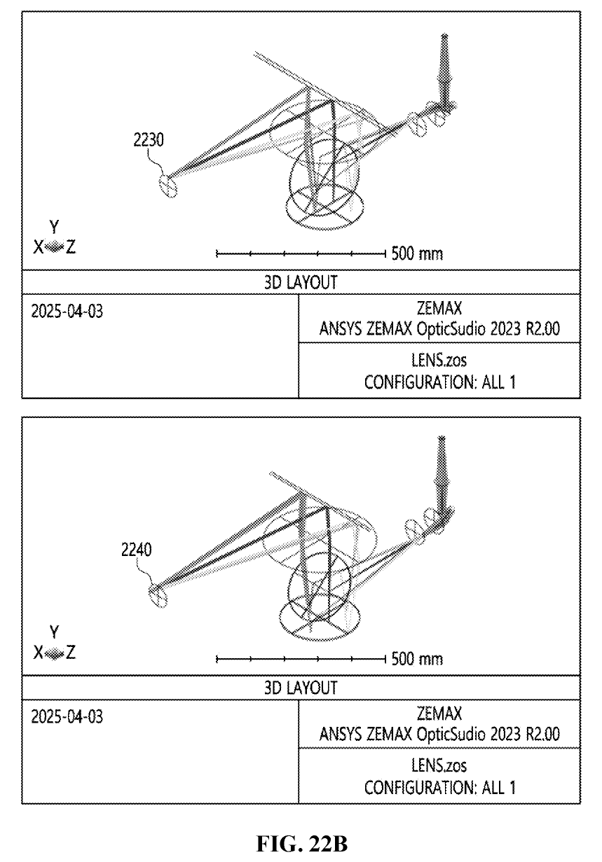

By using such beam steering mirrors, the hologram may be viewed even when the pupils move vertically or horizontally within the range of expanded eye-boxes 2210 to 2240, as illustrated in FIGS. 22A and 22B.

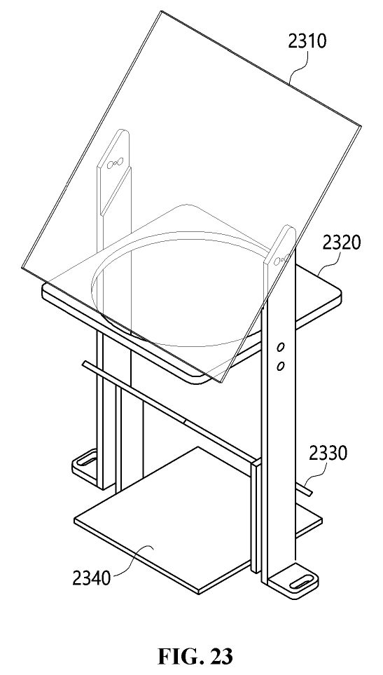

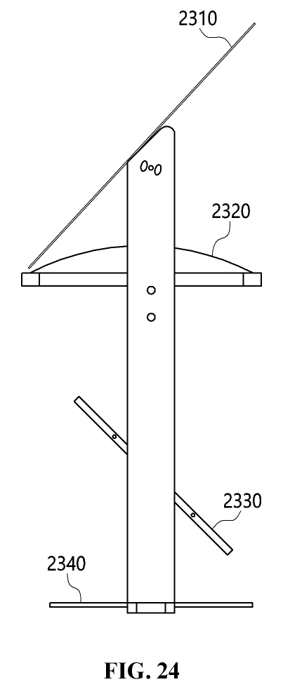

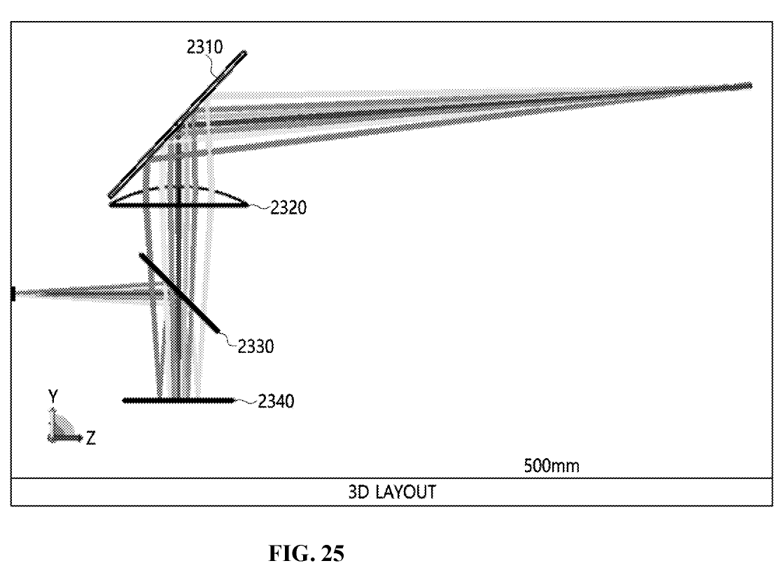

FIGS. 23 to 25 are diagrams illustrating a box-type windshield module according to an embodiment of the present disclosure.

Referring to FIGS. 23 to 25, the box-type windshield module according to an embodiment of the present disclosure may include a windshield 2310, a freeform lens 2320, a half mirror 2330, and a mirror 2340.

In general, the hologram reconstructed image requires a very long projection distance from the holographic projection module in order to achieve a sufficient image size. In addition, the windshield module is also designed to have an appropriate focal length, since a driver must be able to observe the hologram image from a position spaced apart from the windshield by at least 650 mm.

Thus, in order for the hologram reconstructed image to have an appropriate size and position, a very long optical path is required between the holographic projection module and the windshield module. In the present disclosure, to satisfy this requirement within a small volume, the optical path is increased by two to three times compared to a conventional structure using reflections of light, thereby achieving the effect of reducing the size of the optical system.

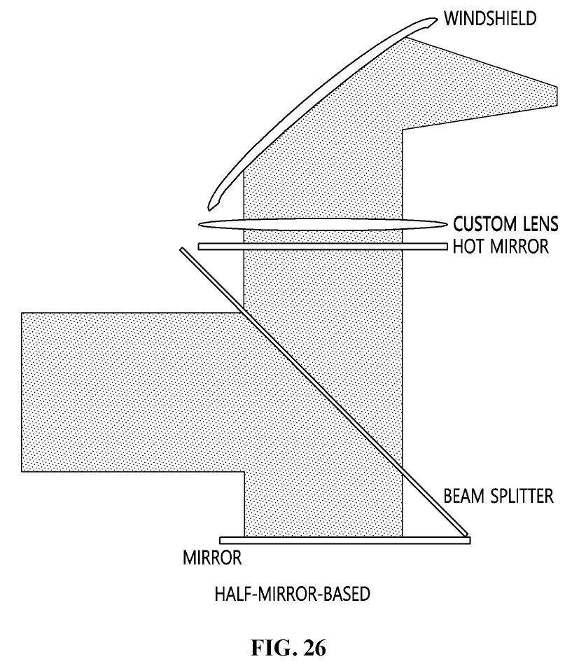

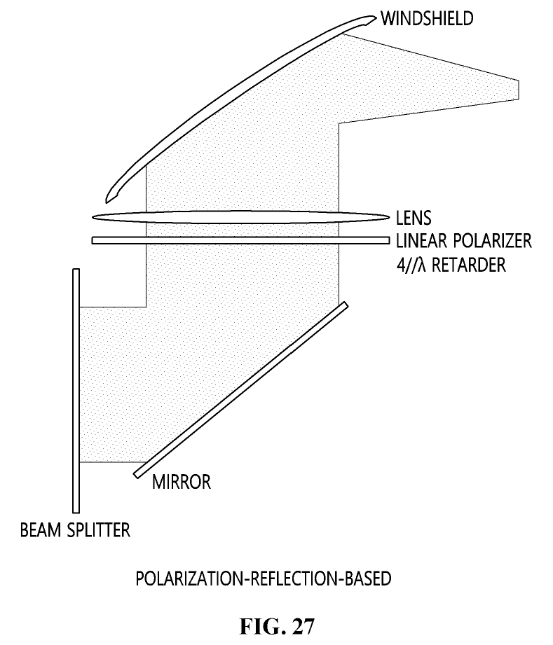

In this case, the box type may include a half-mirror type, in which the optical path is increased by reflecting light based on a half mirror as illustrated in FIG. 26, and a polarization reflection type, in which the optical path is increased by reflecting light based on a quarter waveplate, as illustrated in FIG. 27.

For example, in the polarization reflection type illustrated in FIG. 27, light emitted from the hologram projection module passes through a left-handed circular polarizer and a 50:50 beam splitter, is reflected by a mirror, and then passes through the quarter waveplate, thereby being converted into linearly polarized light. At this time, since an orthogonally oriented linear polarizer is positioned after the quarter waveplate, the light is prevented from being transmitted and is instead reflected. The light reflected in this manner passes through the quarter waveplate again, thereby becoming right-handed circularly polarized light, and after being reflected by the mirror, is reflected again upon encountering the 50:50 beam splitter. Finally, the reflected light passes through the quarter waveplate, thereby having the same polarization direction as that of the linear polarizer and thus being transmitted through the linear polarizer. Through this process, an effect can be obtained in which the optical path is increased by a factor of three while maintaining the same volume.

In this case, the polarization reflection type results in significant optical loss due to the configuration of the optical system and the characteristics of the polarization element. Therefore, if the structure can sufficiently secure the optical path, it may be more effective to use a half-mirror-type windshield module.

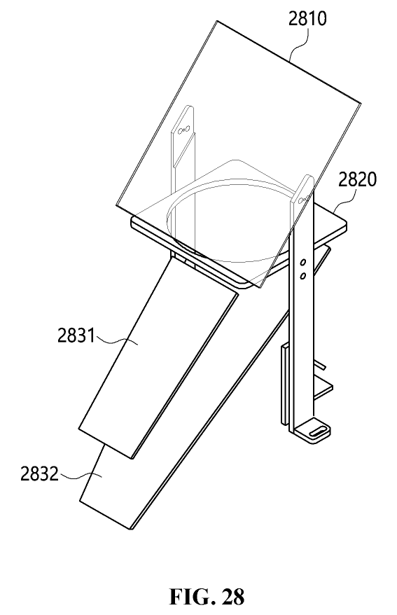

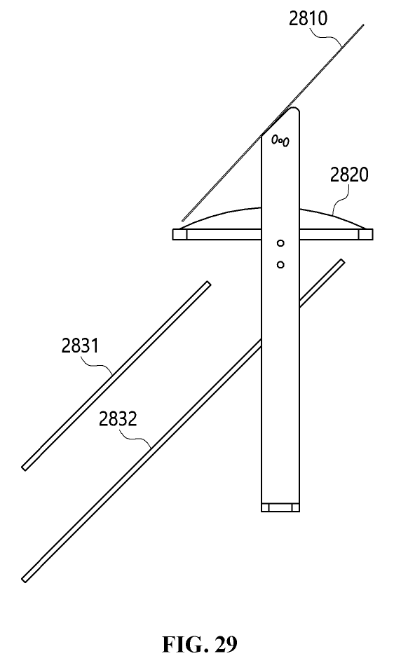

FIGS. 28 to 30 are diagrams illustrating a light-guide-type windshield module according to an embodiment of the present disclosure.

Referring to FIGS. 28 to 30, the light-guide-type windshield module according to an embodiment of the present disclosure may include a windshield 2810, a freeform lens 2820, and two mirrors 2831 and 2832 arranged in parallel.

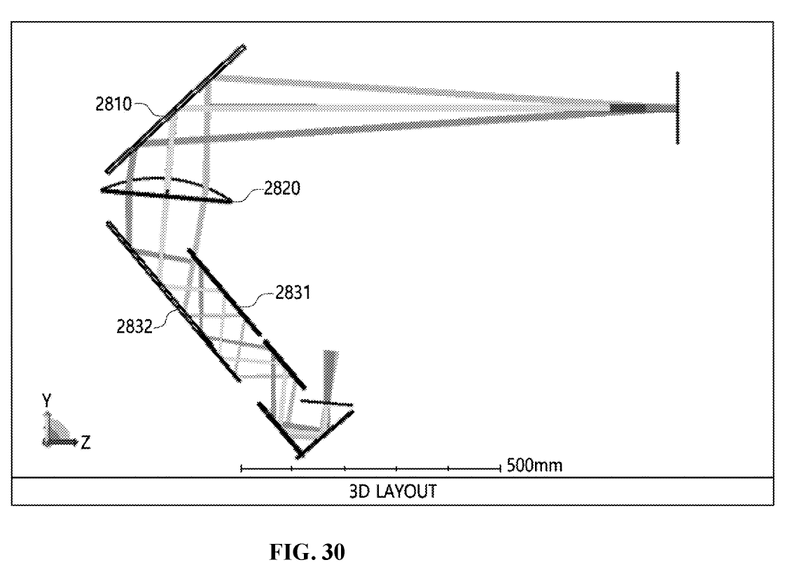

In this case, as illustrated in FIG. 30, the light-guide type may increase the optical path by reflecting light between the two mirrors 2831 and 2832 arranged in parallel.

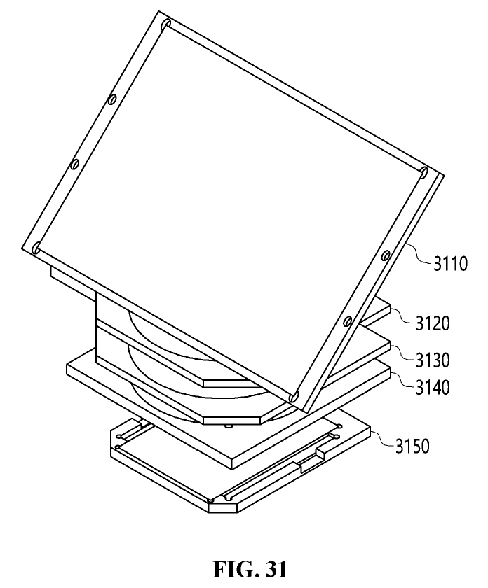

In addition, FIGS. 31 to 33 illustrate a polarization reflection folding-type windshield module according to an embodiment of the present disclosure.

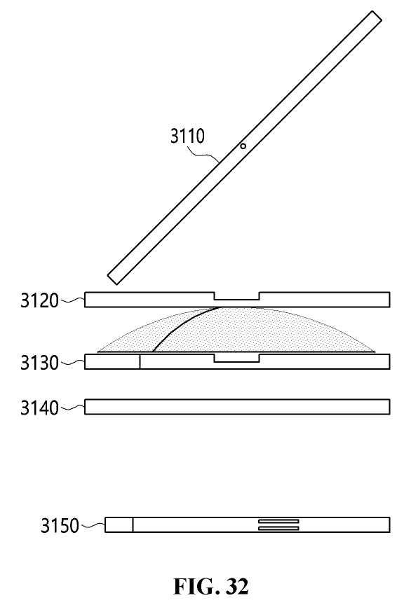

First, referring to FIGS. 31 and 32, the polarization reflection folding-type windshield module according to an embodiment of the present disclosure may include a windshield 3110, a transmissive diffractive optical element 3120, a freeform lens 3130, a linear polarizer 3140, and a 50:50 beam splitter 3150.

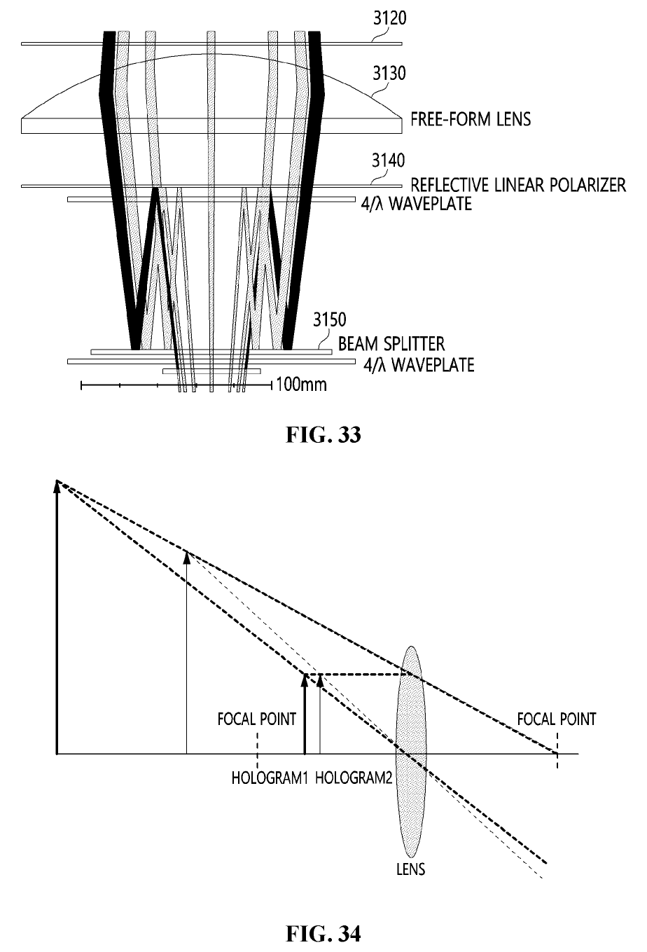

In addition, referring to FIG. 33, light reflected from the two inclined mirrors 1421 and 1422 illustrated in FIG. 14 and passing through the linear polarizer rotated by 45° may be converted into a left-handed circularly polarized component by passing through the quarter waveplate. Thereafter, after light passes through the 50:50 beam splitter 3150, a linear polarizer orthogonal to the quarter waveplate is disposed, such that light is prevented from being transmitted and is reflected. The reflected light passes through the quarter waveplate again to become right-handed circularly polarized light, and is then reflected again by the 50:50 beam splitter 3150. Finally, the reflected light passes through the quarter waveplate, thereby becoming polarized in the same direction as the linear polarizer 3140 and thus being transmitted through the linear polarizer 3140. Through this process, an effect can be obtained in which the optical path is increased by a factor of three while maintaining the same volume.

In this case, a Virtual Image Distance (VID) and a Look Down Angle (LDA) are factors required to provide an image positioned at a distance sufficiently far from a driver and an image that does not obstruct the driver’s field of view. In general, the VID should be provided within a range of 2.5 m to 10 m, and the LDA should be provided at a level of 5° to 8°.

To this end, in the present disclosure, as illustrated in FIG. 34, the hologram reconstructed image projected through the holographic projection module may be formed at a position closer than the focal length of the windshield module. In this case, an erect virtual image is formed to provide an image at a far distance. The present disclosure utilizes this to implement a head-up display capable of continuously adjusting the VID, as illustrated in FIG. 34.

In this case, the windshield module may include a free-form lens designed as a free-form surface to compensate for optical aberrations according to the curvature of the surface on which the erect virtual image of the hologram pattern is formed.

For example, in order to satisfy the LDA, the hologram reconstructed image projected from the hologram should be incident on the windshield module in an off-axis manner. In this case, the windshield is configured to have different horizontal and vertical curvatures, and the off-axis incidence causes distortion in the hologram image and in the eye-box. In the present disclosure, to compensate for such distortion, a free-form lens designed with a free-form surface (e.g., Zernike polynomial, XY polynomial, or Chebyshev polynomial) may be used, as illustrated in FIGS. 13 to 30.

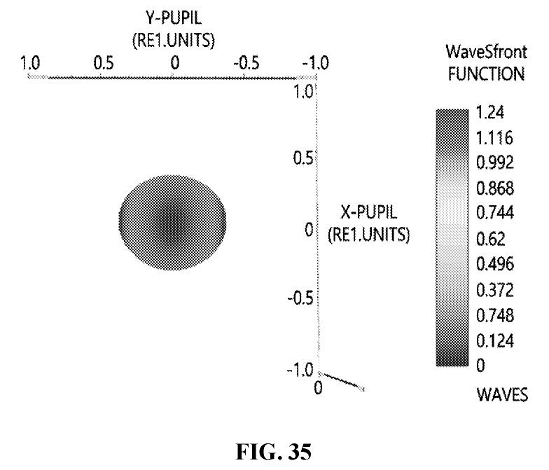

FIG. 35 illustrates an example of a wavefront map of the free-form lens according to the present disclosure.

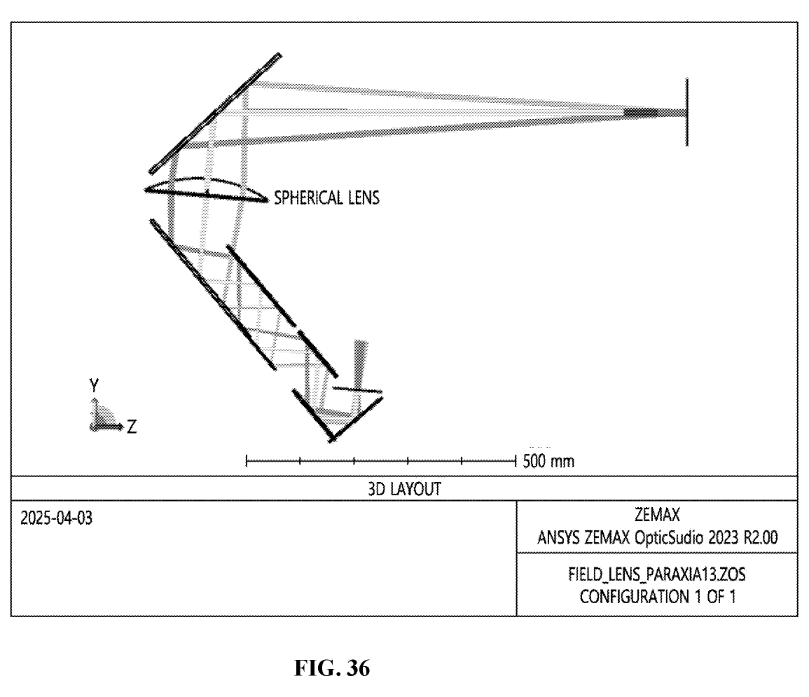

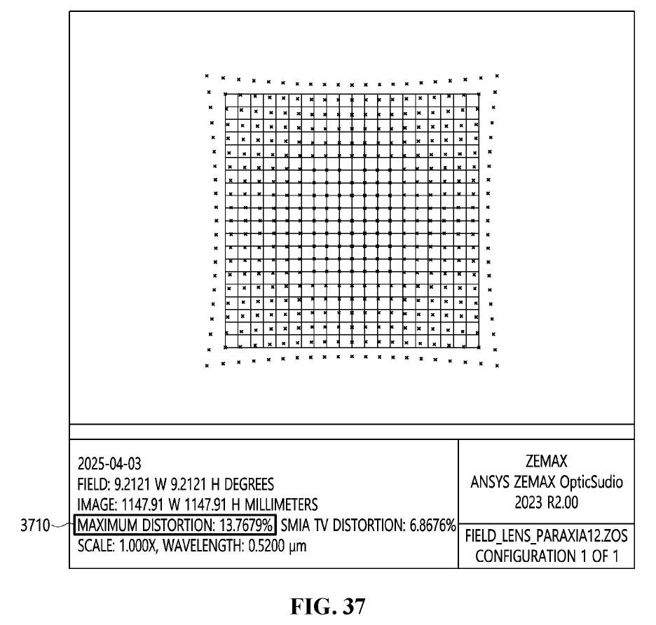

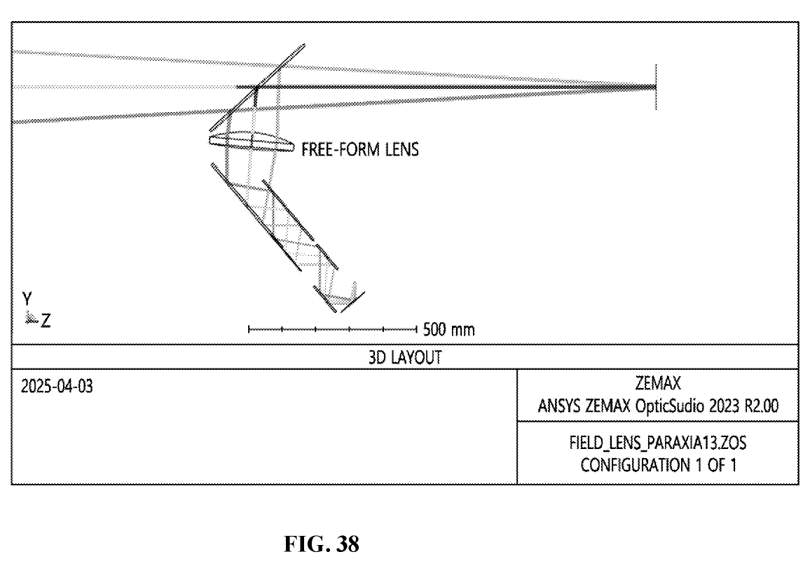

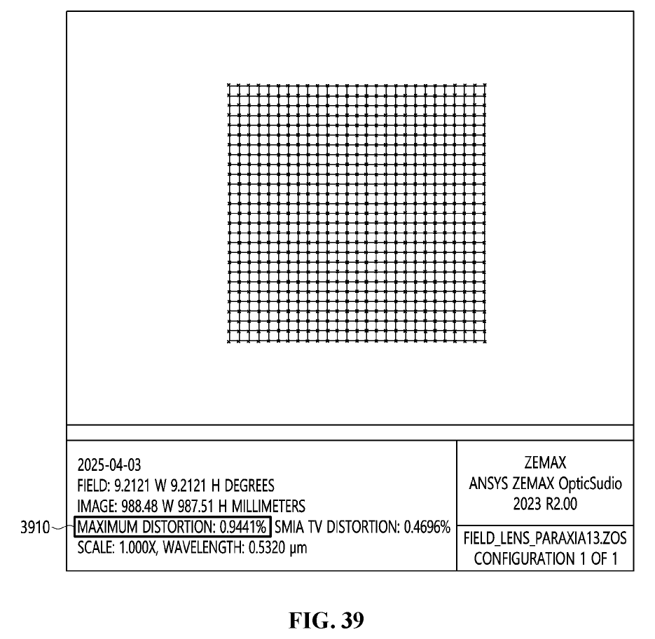

In addition, FIGS. 36 to 39 illustrate an example comparing the degree of distortion when the spherical lens is used and when the free-form lens is used. By comparing the results of FIGS. 37 and 39, it can be seen that a value of maximum distortion is about 13% when the spherical lens is used, whereas the value of maximum distortion is reduced to about 1% when the free-form lens is used.

In the present disclosure, distortion and aberration occurring in the holographic head-up display may be compensated for or corrected using the above-described method. Nevertheless, in the holographic head-up display having a continuous depth, distortion and aberration occur depending on the depth, which may be corrected through compensation and optimization that may be applied later.

As described above, the holographic projection module and the windshield module according to the present disclosure may be variously combined and applied depending on the user’s purpose and the functional requirements of the device.

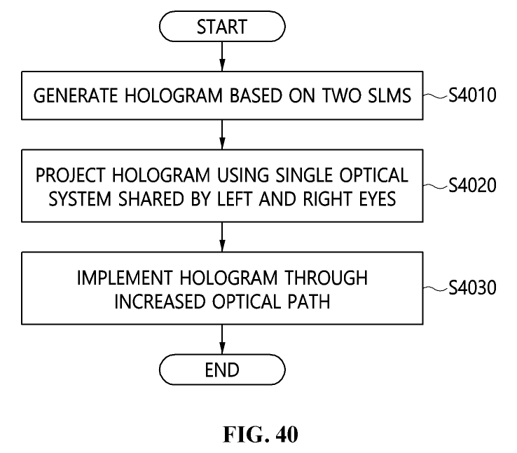

FIG. 40 is an operational flowchart illustrating a hologram providing method according to an embodiment of the present disclosure.

Referring to FIG. 40, in the hologram providing method according to an embodiment of the present disclosure, in the vehicle holographic head-up display apparatus, the holographic projection module generates a hologram pattern at step S4010 by adjusting laser light separated through the polarization beam splitter, based on two spatial light modulators.

Further, in the hologram providing method according to an embodiment of the present disclosure, in the vehicle holographic head-up display apparatus, the holographic projection module projects an image corresponding to the hologram pattern to the windshield module using the single optical system shared by the left and right eyes at step S4020.

In this case, the single optical system may correspond to any one of the following types: a first type in which the hologram pattern is converted into an image and then the image is separated into left-eye and right-eye images using a polarization beam splitter, a second type in which the hologram pattern is separated into left-eye and right-eye patterns using a polarization beam splitter and then the separated patterns are converted into images using a single lens, a third type in which the hologram pattern is separated into the left eye and the right eye using a polarization beam splitter and then the separated patterns are converted into images using left-eye and right-eye lenses, respectively, and a fourth type in which the hologram pattern is converted into an image and then is separated into the left eye and the right eye using an inclined mirror.

In this case, the single optical system may further include a first lens and a second lens for adjusting pixel spacing and expanding the eye-box, a transmissive diffractive optical element disposed between the first lens and the second lens or before/after the fourth lens, and at least one third lens for converting the hologram pattern into an image.

In this case, the transmissive diffractive optical element may be designed to expand an eye-box by replicating a hologram with an identical intensity based on control of diffraction and interference of light such that the replicated holograms are arranged without gaps or overlapped, and to adjust phase values of pixels arranged without gaps or overlapped to correspond to preset parameters, thereby allowing the hologram to be expressed as a single image without distortion.

In this case, the single optical system may further include a first lens and a second lens for pixel-spacing adjustment and eye-box expansion, a reflective diffractive optical element disposed between the first lens and the second lens or before/after the fourth lens, at least one third lens for converting the hologram pattern into an image, and two beam steering mirrors for performing eye tracking based on two-axis control.

In the hologram providing method according to an embodiment of the present disclosure, in the vehicle holographic head-up display apparatus, the windshield module implements an image-based hologram through an increased optical path based on reflection of light at step S4030.

In this case, the windshield module may correspond to any one of a box type using a half mirror or a polarizing optical element, or a light-guide type using two mirrors arranged in parallel.

In this case, the box type may include a half-mirror type, in which the optical path is increased by reflecting light based on the half mirror, and a polarization reflection type, in which any polarized light emitted from the holographic projection module is repeatedly reflected based on the quarter waveplate, the 50:50 beam splitter, and the reflective linear polarizer, thereby increasing the optical path.

In this case, the light-guide type may increase the optical path by mutually reflecting the hologram signal incident at an oblique angle between two mirrors that are parallel to each other.

In this case, the windshield module may include the free-form lens designed as the free-form surface to compensate for optical aberrations according to the curvature of the surface on which the erect virtual image of the hologram pattern is formed.

By using such a hologram providing method, the vehicle holographic head-up display apparatus having the very small volume can provide a hologram that satisfies optical performance requirements such as eye-box (EB), field of view (FoV), virtual image distance (VID), look-down angle (LDA), and image distortion.

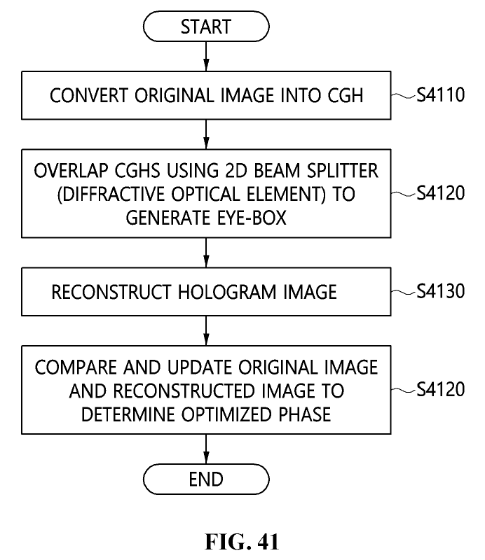

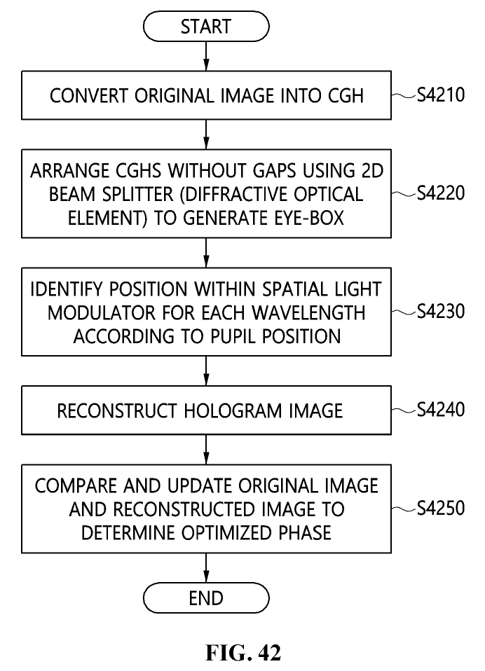

FIGS. 41 and 42 are operational flowcharts illustrating a hologram providing process in an expanded eye-box according to an embodiment of the present disclosure in detail.

First, referring to FIG. 41, an original image may be converted into a Computer-Generated Hologram (CGH) at step S4110, and the converted CGHs may be overlapped using a 2D beam splitter to generate an expanded eye-box at step S4120.

Subsequently, the hologram image may be reconstructed at step S4130, and the original image and the reconstructed image may be compared and updated to determine an optimized phase at step S4140.

In this way, an expanded eye-box formed by overlapping holograms may reproduce a clean hologram by determining and reproducing the phase of overlapped pixels through an optimization algorithm.

In addition, referring to FIG. 42, the original image may be converted into a CGH at step S4210, and the converted CGHs may be arranged without gaps using the 2D beam splitter to generate an expanded eye-box at step S4220.

Thereafter, a position within the spatial light modulator for each wavelength may be identified according to the pupil position at step S4230.

For example, as illustrated in FIG. 18, the effective pixels of the eye-box for each wavelength may be identified according to the pupil position.

Subsequently, the hologram image may be reconstructed at step S4240, and the original image and the reconstructed image may be compared and updated to determine an optimized phase at step S4250.

In this manner, by identifying effective pixels of a wavelength-specific eye-box according to the pupil position and reconstructing a hologram based thereon, double-image and triple-image problems can be resolved.

According to the present disclosure, it is possible to implement a vehicle holographic head-up display apparatus with a very small volume while simultaneously satisfying optical performance requirements and hologram image quality.

As described above, in the vehicle holographic head-up display apparatus and method for providing the hologram using the same according to the present disclosure, the configurations and schemes in the above-described embodiments are not limitedly applied, and some or all of the above embodiments can be selectively combined and configured so that various modifications are possible.

What is claimed is:

1. A vehicle holographic head-up display apparatus, comprising:
a holographic projection module including two spatial light modulators configured to generate a hologram pattern by modulating laser light separated through a polarization beam splitter, and including a single optical system shared by the left and right eyes; and
a windshield module having an increased optical path based on reflection of light.

2. The vehicle holographic head-up display apparatus of claim 1, wherein the single optical system corresponds to any one of a first type in which, after converting the hologram pattern into an image, the image is separated into left-eye and right-eye images using a polarization beam splitter, a second type in which the hologram pattern is separated into left-eye and right-eye patterns using the polarization beam splitter and the separated patterns are then converted into images by a single lens, a third type in which the hologram pattern is separated into left-eye and right-eye patterns using the polarization beam splitter and the separated patterns are converted into images using left-eye and right-eye lenses, respectively, and a fourth type in which, after converting the hologram pattern into an image, the image is separated into left-eye and right-eye images using an inclined mirror.

3. The vehicle holographic head-up display apparatus of claim 2, wherein the single optical system further comprises a first lens and a second lens for pixel-spacing adjustment and eye-box expansion, a transmissive diffractive optical element located between the first lens and the second lens or before or after a fourth lens, and at least one third lens for converting the hologram pattern into an image.

4. The vehicle holographic head-up display apparatus of claim 3, wherein the transmissive diffractive optical element is designed to expand an eye-box by replicating a hologram with an identical intensity based on control of diffraction and interference of light such that the replicated holograms are arranged without gaps or overlapped, and to adjust phase values of pixels arranged without gaps or overlapped to correspond to preset parameters, thereby allowing the hologram to be expressed as a single image without distortion.

5. The vehicle holographic head-up display apparatus of claim 3, wherein the single optical system further comprises two beam steering mirrors configured to perform eye tracking based on two-axis control.

6. The vehicle holographic head-up display apparatus of claim 1, wherein the windshield module corresponds to any one of a box type using a half mirror or a polarizing optical element, and a light-guide type using two mirrors arranged in parallel.

7. The vehicle holographic head-up display apparatus of claim 6, wherein the box type comprises a half-mirror type in which light is reflected based on the half mirror, thereby increasing the optical path, and a polarization reflection type in which any polarized light emitted from the holographic projection module is repeatedly reflected based on a quarter waveplate, a 50:50 beam splitter, and a reflective linear polarizer, thereby increasing the optical path.

8. The vehicle holographic head-up display apparatus of claim 6, wherein the light-guide type increases the optical path by mutually reflecting a hologram signal incident at an oblique angle between two mirrors arranged in parallel.

9. The vehicle holographic head-up display apparatus of claim 1, wherein the windshield module comprises a free-form lens designed with a free-form surface to compensate for optical aberrations according to a curvature of a surface on which an erect virtual image of the hologram pattern is formed.

10. A hologram providing method performed by a vehicle holographic head-up display apparatus, the hologram providing method comprising:
generating, by a holographic projection module, a hologram pattern by modulating laser light separated through a polarization beam splitter based on two spatial light modulators;
projecting, by the holographic projection module, an image corresponding to the hologram pattern onto a windshield module using a single optical system shared by a left eye and a right eye; and
implementing, by the windshield module, a hologram based on the image through an increased optical path based on reflection of light.

11. The hologram providing method of claim 10, wherein the single optical system corresponds to any one of a first type in which, after converting the hologram pattern into an image, the image is separated into left-eye and right-eye images using a polarization beam splitter, a second type in which the hologram pattern is separated into left-eye and right-eye patterns using the polarization beam splitter and the separated patterns are then converted into images by a single lens, a third type in which the hologram pattern is separated into left-eye and right-eye patterns using the polarization beam splitter and the separated patterns are converted into images using left-eye and right-eye lenses, respectively, and a fourth type in which, after converting the hologram pattern into an image, the image is separated into left-eye and right-eye images using an inclined mirror.

12. The hologram providing method of claim 11, wherein the single optical system further comprises a first lens and a second lens for pixel-spacing adjustment and eye-box expansion, a transmissive diffractive optical element located between the first lens and the second lens or before or after a fourth lens, and at least one third lens for converting the hologram pattern into an image.

13. The hologram providing method of claim 12, wherein the transmissive diffractive optical element is designed to expand an eye-box by replicating a hologram with an identical intensity based on control of diffraction and interference of light such that the replicated holograms are arranged without gaps or overlapped, and to adjust phase values of pixels arranged without gaps or overlapped to correspond to preset parameters, thereby allowing the hologram to be expressed as a single image without distortion.

14. The hologram providing method of claim 12, wherein the single optical system further comprises two beam steering mirrors configured to perform eye tracking based on two-axis control.

15. The hologram providing method of claim 10, wherein the windshield module corresponds to any one of a box type using a half mirror or a polarizing optical element, and a light-guide type using two mirrors arranged in parallel.

16. The hologram providing method of claim 15, wherein the box type comprises a half-mirror type in which light is reflected based on the half mirror, thereby increasing the optical path, and a polarization reflection type in which any polarized light emitted from the holographic projection module is repeatedly reflected based on a quarter waveplate, a 50:50 beam splitter, and a reflective linear polarizer, thereby increasing the optical path.

17. The hologram providing method of claim 15, wherein the light-guide type increases the optical path by mutually reflecting a hologram signal incident at an oblique angle between two mirrors arranged in parallel.

18. The hologram providing method of claim 10, wherein the windshield module comprises a free-form lens designed with a free-form surface to compensate for optical aberrations according to a curvature of a surface on which an erect virtual image of the hologram pattern is formed.
